(19) United States
(12) Patent Application Publication
(10) Pub. No.: US 2021/0092238 A1
(43) Pub. Date: Mar. 25, 2021

(54) CLOUD-BASED DOCUMENT MANAGEMENT SYSTEM

(71) Applicant: Scanning Revolution LLC, Salt Lake City, UT (US)

(72) Inventors: Daniel Gill, South Jordan, UT (US); Dee Acharjya, Salt Lake City, UT (US)

(21) Appl. No.: 16/577,690

(22) Filed: Sep. 20, 2019

(51) Int. Cl. H04N 1/00

(52) U.S. Cl. CPC H04N 1/00222; H04N 1/00973; H04N 1/00331

(57) ABSTRACT

Cloud-based document management systems are disclosed that provide a direct link between a scanner and cloud storage. In embodiments, a document management system provides a web scanning application that is executable in a web browser. The application can initiate a scan from a scanner in communication with the web browser that is transmitted directly to a remote cloud storage location and indexed by the document management system without requiring storing a copy of the document local to the web browser. Other embodiments allow printing from the web browser directly to the document management system and remote cloud storage. In another aspect, a receipt printer buffer is provided that can provide electronic receipts that may be directly uploaded to the cloud-based document management system.

### TECHNICAL FIELD

The present disclosure relates to the field of document management systems, and specifically to a document management system that is at least partially cloud-based.

### BACKGROUND

Any business, in the course of operation, is faced with various record keeping requirements, whether customer related, such as a customer list and/or other customer-related records; financial records, such as receipts, invoices, tax documents, etc.; employee records, such as performance reviews and files; and/or other various records. Historically, the records were predominantly produced in hard copy format, and so required some form of physical storage, in addition to requiring physical access to and possibly transport of any needed documents. With the advent of relatively high-powered business computing systems, capable of rapid retrieval and display of high-resolution images, as well as the Internet, which has enabled on-line transactions and a remote work force (including virtual offices), record keeping is increasingly moving paperless. Records can either be scanned or otherwise digitized from paper originals, or entirely originated digitally, such as an e-mail or word processing file.

In addition to computer or server storage space, paperless recording keeping also requires a filing system to allow needed stored documents to be retrieved from the computer or server. A Document Management System (DMS) is software that can provide both filing of electronic documents as well as a way of tracking and retrieving any needed documents. A DMS is the use of a computer system and software to store, manage, and track electronic documents and electronic images of paper-based information captured through the use of a document scanner.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 is a block diagram of the components of an example document management system and scanner, as may be implemented with the known state of the art.

FIG. 2A is a block diagram of the components of an example document management system with associated cloud storage and scanner that uses a web browser for an interface, according to various embodiments.

FIG. 2B is a block diagram showing the components of an example scanning web app and their interaction with components of the example system of FIG. 2A, according to various embodiments.

FIG. 3 depicts an example user interface for interacting with the system of FIG. 2A, according to various embodiments.

FIG. 4 is a flowchart of an example method for directly scanning or printing a document from a client device into a DMS and associated cloud storage, such as the example system of FIG. 2A, according to various embodiments.

FIG. 5A is a block diagram of an example system for providing an e-receipt and/or printed receipt at a point-of-sale terminal, which may interface with a DMS such as the example system of FIG. 2A, according to various embodiments.

FIG. 5B is a block diagram of the components of an example receipt printer buffer that may be used with the example system of FIG. 5A, according to various embodiments.

FIG. 6 is a block diagram of an example computer that can be used to implement some or all of the components of the example systems of FIGS. 2A, 2B, 5A, and 5B, according to various embodiments.

FIG. 7 is a block diagram of a computer-readable storage medium that can be used to implement some of the components of the system or methods disclosed herein, according to various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

One of the objects of a DMS is to identify and retrieve a stored or otherwise managed document quickly when it is needed. To realize such operation, putting a tag or an index with documents is important. However, scanning paper to generate electronic data (e.g., into a PNG, PDF, TIFF, JPEG, DOC, or other suitable image or document format) followed by association with the proper tag(s) or index can be time-consuming work. In currently known DMS solutions, a user typically first needs to go to a scanning workstation (unless the user's workstation is already equipped with a scanner), such as a properly-configured workstation to which a scanner machine is attached, put the papers to be digitized on the scanner, set a destination (such as a folder or email address) to send the electronic data, and then start scanning.

Following scanning, the user typically must go to a PC or other computer equipped with any necessary software to interface with the DMS (again, unless the user's workstation is equipped with the necessary software), to see and classify the received electronic data, and store those data to a proper location in the document storage (such as a cloud service or file server). Depending upon the implementation, the DMS may not automatically update the list of available documents to reflect the document or documents scanned by the user, but instead require the user to refresh the document list to reveal the newly scanned document(s). Considering the number of steps involved to capture and appropriately classify a scanned document, if there are thousands of papers to be scanned, the process can become extremely cumbersome and/or time consuming.

For documents that originate electronically, viz. the document is already in digital or electronic format and so does not require scanning or digitization, the scanning step is not required. However, the document must still be tagged with any appropriate metadata and filed correctly into the DMS. Storing electronic documents at a proper location in the cloud storage or other document repository with proper tag or index information by using a browser may still require multiple steps.

The foregoing limitations are at least partially a result of the typical software stack utilized to connect a scanner to a workstation, PC, Mac, or other computer (referred to generically herein as “PC”). Scanners typically communicate with PCs by using an application programming interface (API). APIs currently in use for most scanner applications include TWAIN, Image and Scanner Interface Specification (ISIS), or Windows Image Acquisition (WIA) Technology. TWAIN is a relatively popular API and protocol that most scanners support, and has been in use for several decades. The ISIS API was developed to provide a higher-speed interface. WIA was developed by Microsoft as a replacement for TWAIN, but currently is only supported by a limited number of industrial scanners. For example, Fujitsu, Canon, and Kodak, each makers of industrial-grade scanners, don't incorporate WIA drivers into their provided software stacks. While most scanners are controlled via one or more of TWAIN, WIA or ISIS, none of those APIs provide functionality for the browser to communicate with the scanner.

A further problem presented by the foregoing software stack and scanner connection is the lack of support for direct connection to a mobile device, such as a smartphone or tablet. With known systems, access to a DMS via a smartphone, tablet, or similar mobile device typically would require some form of dedicated application. Furthermore, because scanners typically cannot be directly connected to a smartphone or tablet, scanning documents using a tablet or smartphone would require access to at least a network-connected scanner (such as may be found on a multi-function device, which may provide printing and scanning functions on a device that can connect directly to a local area network), which again typically requires the installation of dedicated software to control scanning. Scanning directly to a DMS from a mobile device is not feasible, absent supporting software.

Regardless of whether scanning is performed straight to a PC or workstation, or on a mobile device via scanning software and a network-attached scanner, in either scenario, documents are initially scanned to and stored locally upon either the PC or mobile device. Following scanning, the locally stored document(s) is/are uploaded to the DMS, leaving a local copy of the document(s). Where multiple documents are scanned, such as in a batch scanning process, these copies can quickly overwhelm local storage on either the PC or mobile device unless purged after upload. As each document may need to be tagged or otherwise cataloged for entry into the DMS, it may not be feasible to delete each document following uploading to the DMS without significantly increasing the amount of time required to process each document. Moreover, the two-step process of scanning followed by uploading itself increases the amount of time required to process each scanned document into the DMS.

Disclosed embodiments address the foregoing problems by providing a DMS that can be cloud-based, can interact with cloud-based storage services, and provides scanning functionality through a standard web browser, such as Google Chrome, Microsoft Edge, or Mozilla Firefox. Specifically, disclosed embodiments include a DMS that enables scanning directly from a suitable web browser without the need to install and maintain a scanner and/or application-specific software stack. The DMS further establishes, via the browser, a direct connection between a scanner attached to a PC and the DMS. The DMS may be remotely located, so that documents can be scanned directly into the DMS without the need for first scanning to a local copy, then uploading. Thus, the need for local storage is significantly reduced. Furthermore, the use of a standard web browser allows access to the DMS and direct scanning from a mobile device, such as via a connection to a network-attached scanner. By integrating the DMS interface and scanning controls into a browser, document lists can automatically refresh with each scanned and uploaded document. Disclosed embodiments thus realize a cost effective one-step solution to manage documents by using a standard web browser.

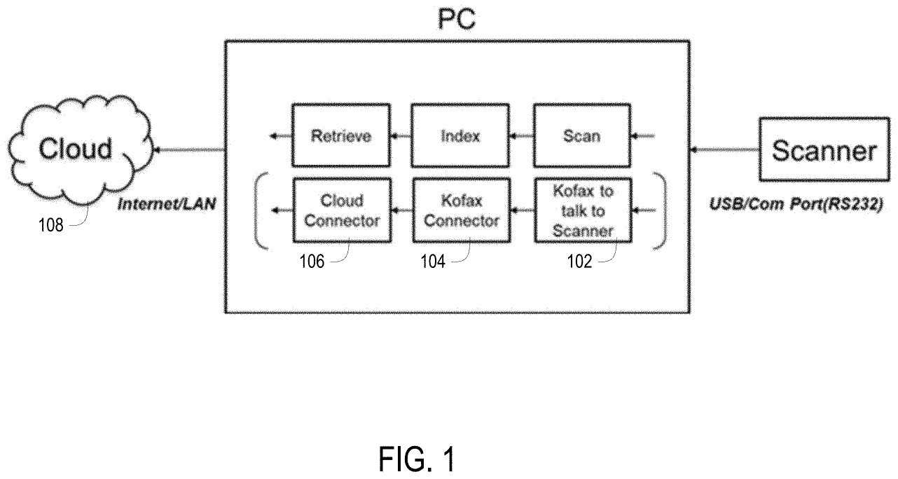

FIG. 1 illustrates the approach taken by typical existing document management systems. In the depicted approach, three different native software applications 102, 104, and 106 are needed for such operation. The first application 102 is the software application to drive scanning. In one possible example for high speed scanning, the scanning solution vendor provides an accelerator board combined with an ISIS-based driver. The second software application 104 attaches an index to the documents. The scanning solution vendor, as a part of a built-in DMS, may provide such indexing software. The third software application 106 retrieves data from the PC to store to a cloud storage service 108. The scanning solution vendor may provide the software for such operation. Other scanning is another example of a native app, which pushes images to the cloud storage service 108.

Typically, since there are three different software applications, user has to conduct three different manipulations, namely: 1. go to a workstation with an attached scanner machine, put papers on the scanner, set destination folder or email address to send electronic data and then start scan; 2. go back to desk, confirm data is actually sent from the scanner, open a DMS software application, and attach index metadata to scanned documents; and 3. open a cloud interface application, and use it to store the data to a proper location in a cloud storage surface. In some embodiments, step 3 may be carried out or facilitated by the DMS application.

The foregoing steps can become troublesome, and particularly time consuming, if there are thousands of papers to scan. The three applications typically also each have independent schedules for releasing updated versions, so they can impose a significant information technology maintenance burden. In some cases, a DMS software application may combine capabilities for all three of these operations. However, such native software is typically expensive, and at a minimum, requires software or drivers be installed on a PC. Installing the native software is sometimes difficult for persons who do not have enough knowledge about PC. Furthermore, such software typically precludes use from a mobile device, or only offers limited functionality.

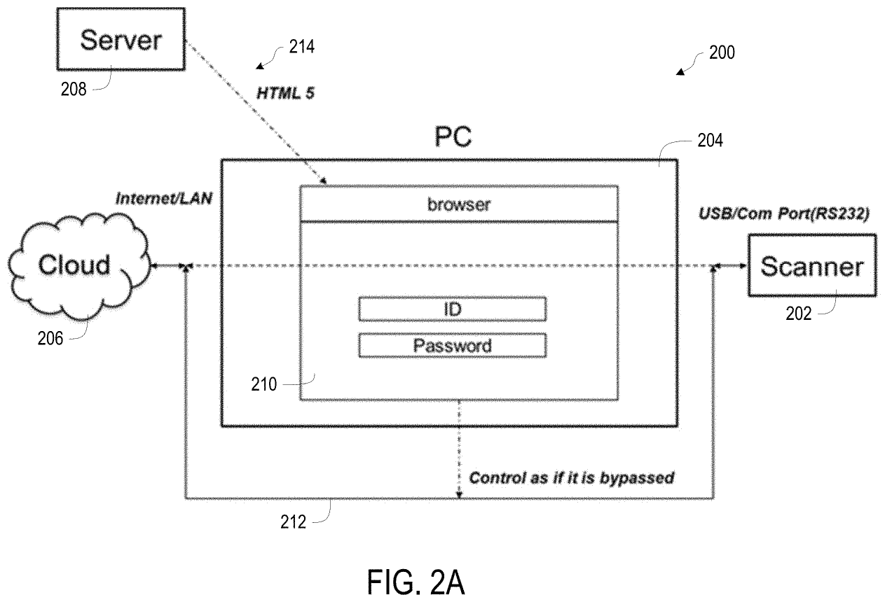

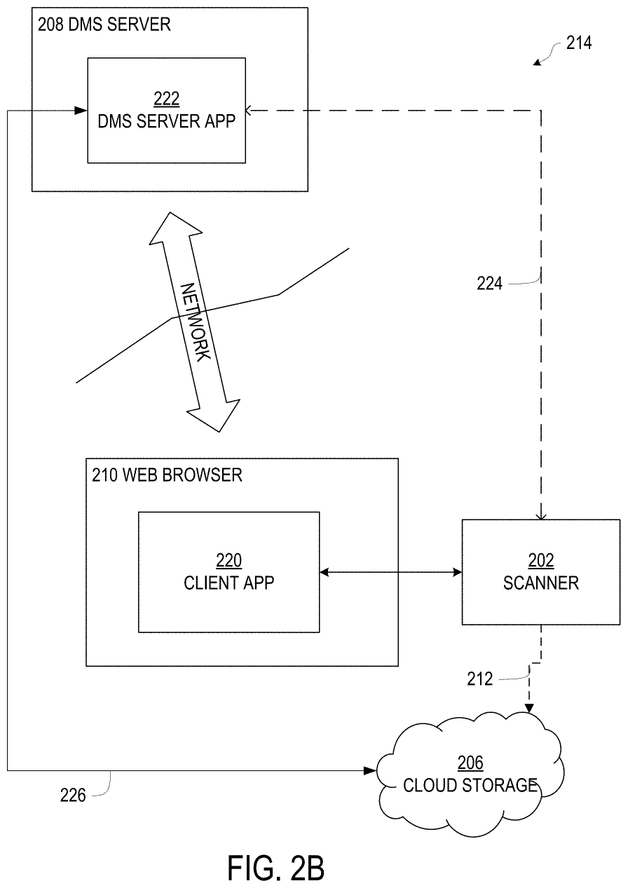

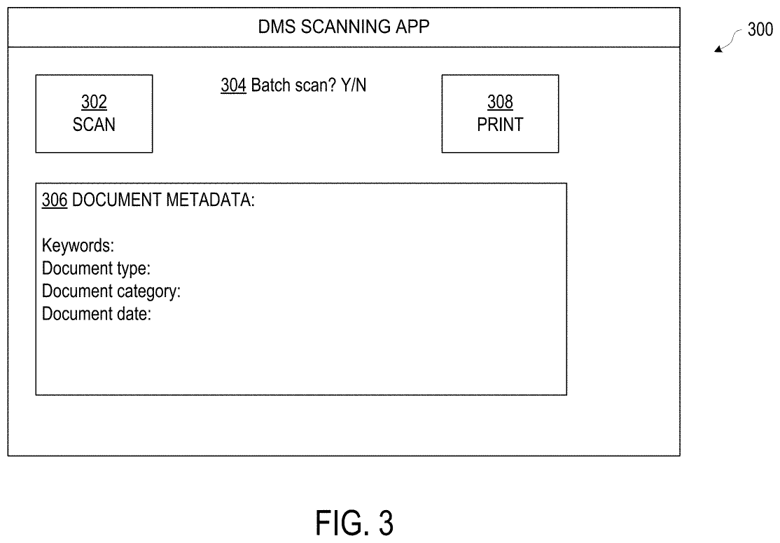

FIG. 2A depicts an example system 200, according to one possible embodiment, that provides a web browser-based interface, described below with reference to FIG. 3, to enable and control scanning directly into a cloud-based DMS. In some embodiments, the DMS and cloud-based storage may be provided by a single service provider, with the cloud-based storage integrated into the DMS. In other embodiments, the cloud-based storage may be offered by a provider separate from the DMS provider, such as an existing cloud storage provider like Box, Dropbox, OneDrive, Google Drive, or a similarly suitable cloud storage provider. Implementing the DMS as a web application enables scanning from the browser to a cloud service using a logically direct communication path from the scanner to the cloud service. Various examples may be referred to below as a scanning web app 214. In the depicted example, a scanner 202 is locally connected to a PC 204 via a suitable data connection, such as USB or Firewire. The PC 204 is connected to the cloud service 206 via a network, which could either be a wide area network, such as the Internet, or local area network (LAN) connection. The PC 204 is further connected to a server 208, which may host the DMS and provide the scanning web app 214 to a browser 210 on the PC 204, as will be discussed below in more detail.

It should be understood that, although the embodiments described below assume that scanner 202 is a TWAIN-compliant document scanner, scanner 202 could be implemented as any device that is suitable for digitizing physical documents or other 2-D or 3-D objects. Other possible scanning devices that may be usable with system 200 include cameras, digitizers, scanning pens, laser scanners, or any other similarly suitable device. Where scanner 202 is implemented as a device other than a conventional TWAIN compliant scanner, other appropriate device interfaces may be supplied by the operating system. For example, scanner 202 may be a network scanner connected to PC 204 via LAN connection.

Referring to FIG. 2B, in one embodiment, the scanning web app 214 may include a client side web app 220 that communicates with the attached scanner 202 via a suitable API (which may be provided by the operating system or may be downloaded from server 208 when user first log in to cloud-based DMS), such as TWAIN. Client side web app 220 uses custom URLs, enables running an execution file from the browser 210, and/or uses a communications protocol that allows for push messaging, such as WebSockets or a comparably suitable interface. In some embodiments, the client side web app 220 may be coded at least partially in HTML 5. The client side web app 220, running on the browser 210, may have or otherwise communicate via a unique, custom URL associated with a cloud storage space, which may correspond to an available storage on the cloud service 206. Scanning web app 214 further may include a server application 222 associated with the custom URL, which may run upon DMS server 208. Server application 222 may perform various DMS functions, such as indexing, database management, and coordination of communication between the client side web app 220 and cloud storage 206, such as for locating and retrieving documents managed by the system 200 upon request by a user. Server application 222 may be written in any suitable language or code, e.g. C, C++, C#, HTML 5, Java, etc.

The scanning web app 214 may initiate and control scans by the scanner, illustrated by the logical connection 224. Specifically, HTML 5 provides mechanisms by which a scanner can be accessed directly through a web browser, by interfacing with an operating system device driver or other interface. Thus, in one possible embodiment, the web browser 210, under instruction from scanning web app 214, interfaces with scanner 202 via an API such as TWAIN, possibly offered by the operating system. Scanning initiation, upon a user issuing a request to scan, may be triggered by the client-side web app 220, the server application 222, or with cooperation from both the web app 220 and server application 222. In some embodiments, scanning web app 214 may establish a logical or virtual connection, such as via a custom URL (discussed below), between either or both of the server 208 (logical connection 224) or storage on the cloud service 206 (logical connection 212), and the scanner 202. This connection can facilitate direct scanning of documents from scanner 202 into the storage of cloud service 206, without the need for a local copy stored upon PC 204.

The client-side web app 220 may use WebSockets or another suitable communications protocol or software stack to push a scanner message to the server application 222 to inform the server application 222 once a scan is done. Once the server application 222 receives a message that a scan is complete and receives any metadata from the user, which may be input into an interface to the DMS (discussed below with respect to FIG. 3), the scanning web app 214 may attach the metadata to the scanned images, and transfer the scanned images with attached metadata from the scanner 202 directly to the associated cloud storage service 206. Depending upon the implementation, either the client-side web app 220 or the server application 222 may be responsible for attaching the metadata. As a result, as shown in FIGS. 2A and 2B, the data encoding the scanned documents or other images are directly transferred, shown as the direct logical connection 212, from the scanner 202 to the cloud service 206 storage as if bypassing the PC 204. That is, the scanning web app 214 may load the scanned documents directly from the scanner 202 to the storage on cloud service 206 without the scanned documents ever being stored on the client computer.

While a local copy of a scanned document need not be stored on PC 204, depending on the nature of PC 204 and its corresponding network connections, a scanned document may be temporarily cached or buffered to local storage on PC 204, such as where network congestion prevents transmission of the document data at the same rate at which the scanner 202 is able to generate the data. Such caching to temporary storage will, in most embodiments, be automatically handled by the scanning web app 214 without need for user intervention or even knowledge, and will be automatically deleted following completion of document transmission to the cloud service 206 or DMS.

In some examples, the scanning web app 214, and in particular the server application 222 may, via the browser 210 running client-side web app 220, receive data from the scanner 202 as raw TWAIN bitmap data, convert the raw TWAIN bitmap data into image files, attach any user-entered indexing metadata to the image files, and store the image files on the cloud storage service 206. In some examples, the scanning web app 214 may transmit the raw TWAIN bitmap data via the client-side web app 220 of the scanning web app 214 running in the browser 210 to the server application 222 of the scanning web app 214, and so perform the conversion of the raw data into document format files, or another suitable format, in the cloud. In one example, the scanning web app 214 converts the raw TWAIN bitmap data into PNG format files, and then, if the user has selected a different file format option, converts the PNG format files into files of the selected format, e.g. PDF, TIFF, or JPEG files. In other embodiments, the raw data make take another form, such as where a TWAIN interface is not used to communicate with scanner 202. In such embodiments, the raw data make take another format as provided by scanner 202 and/or any operating system interface. In some embodiments, the file format stored in the cloud may be determined via user selection through the browser 210. The DMS of system 200 may convert raw bitmap via TWAIN from the scanner into file types such as PNG, PDF, TIFF, JPEG, or other image format.

In embodiments where a conversion of the raw scanner data is carried out by server application 222, the logical or virtual connection from scanner 202 may run between scanner 202 and the server application 222, depicted in FIG. 2B as connection 224. Following processing, the server application 222 in turn may forward the converted data/file format to the cloud storage 206, via connection 226. As seen in FIG. 2B, connection 226 does not pass through web browser 210, let alone client-side web app 220.

The scanning web app 214, either the client side web app 220 and/or the server application 222, depending upon the specifics of a given implementation, can output one or more user interface (UI) elements, such as a popup or other prompt, for a user to input catalogue metadata such as a tag, index, or date. Examples of these UI elements are shown in FIG. 3, which depicts an interface 300 that may be usable into system 200, according to one possible embodiment.

In one example, the scanning web app 214 interface 300 includes a “scan from browser” or scan button 302, which may be enabled and/or presented following login, if required, to the website or other interface to server 208 of the provider of system 200. Once logged in, the user can select the scan button 302, and thereby initiate the scan from browser function. Actuating the scan button 302 can, depending upon the embodiment, either cause the client side web app 220 to directly signal the scanner 202, such as via the operating system driver, or may send a message to the server application 222, which then may send the appropriate initiation command to scanner 202. The scan button 302 may include batch scan settings 304 for large batches of documents to be scanned.

In response to a user input selecting the scan from browser button 302, the scanner 202 starts scanning, and the scanning web app UI presents a UI element 306 (such as a popup) for the user to input catalogue metadata, including but not limited to a tag, an index, or a date, for the documents. In the example shown in FIG. 3, metadata UI element 306 includes locations to enter various document metadata such as keywords, document type (e.g. PDF, DOC, XLS), document category, and document date. It should be understood that these are examples; the specific metadata captured, and method of capture, by a given implementation may vary widely depending upon the needs of the given implementation. Some implementations may be configured with a default set of metadata that are assigned, absent specific metadata provided by the user. As one example, the storage space offered via cloud service 206 is allocated based on the

Attorney Docket No. 134511-250089_P001 Transmission Date: September 20, 2019 account, and once all catalogue metadata input, scanned documents are directly stored on such space with inputted catalogue metadata (e.g., tag, index, or date). Once stored in the cloud, a user may easily identify, seek, or retrieve stored documents by using tag, index, date, or other attached metadata, as in a full native DMS. The web app may also enable full-text search to complement metadata index search capability.

Referring back to FIGS. 2A and 2B, scanning web app 214 creates a virtual or logical link 212 via browser 210 around a client computer, e.g. PC 204, directly between the scanner 202 and storage offered via cloud service 206, replacing the three different native apps 102, 104, and 106 required by known solutions. As discussed above with respect to FIG. 1, the applications 102, 104, and 106 are configured to talk to each other, but each may be subject to their own independent upgrade schedules; e.g., application 102 to talk to scanner, application 104 for providing interaction between the user and the DMS, and application 106, to connect with the cloud storage provider. In contrast, the browser 210 may be a thin client interface to the scanning web app 214, and does not need applications 102, 104, or 106. The scanning web app 214 may initiate or otherwise tell the scanner 202 to scan. The scanner 202 may generate the scanned data as raw bitmap data and notify the scanning web app 214 once scanning is complete.

The scanning web app 214 may use a custom URL to receive the scanner data. In some embodiments, the custom URL may direct the scanner data directly to the cloud service 206, for storage. The system 200 may also include a software development kit (SDK) for the scan to cloud web app. Because the environment of browser 210, in embodiments, is in isolation from the host machine PC 204, new functions to system 200 can be easily implemented in upgrades provided by the provider of system 200. Furthermore, the provider of system 200 may enable live updates in the browser (e.g., no refresh needed) by using WebSockets technology. Such live updates may allow browser 210 to automatically update any document lists that are currently displayed with new documents as they are added and indexed into system 200. In some examples, the scan from browser innovation works with any TWAIN-compliant scanner, which means virtually any scanner on the market.

As discussed above, because all, or substantially all, functions of system 200 are able to be run and/or controlled on a browser 210, it is not necessary to install respective native applications, which may be troublesome. The scanning web app 214 doesn't store or retain copies of scanned documents on local storage on the client computer PC 204. It transmits the image data to web app directly without creating a local copy (saving any buffering that may be necessary due to network conditions), while raw bitmap data may be buffered to convert into another image format such as PNG, PDF, TIFF or JPEG. Thus, the scan to cloud functionality of system 200 may enable very fast, indexed, secure, highly searchable large-scale document storage in the cloud, and democratize smart document storage.

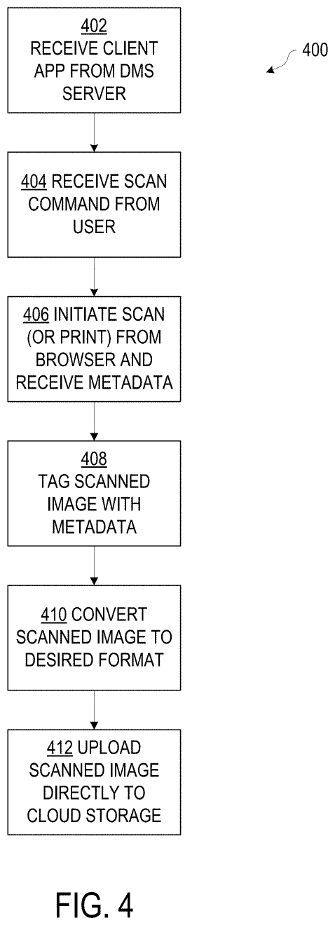

FIG. 4 depicts an example method 400 for scanning documents into a DMS via a web browser. The operations of method 400 may be carried out by a DMS such as system 200, in whole or in part. Moreover, the operations need not be carried out in the precise order depicted in FIG. 4. The DMS may be accessed by a device running an HTML 5 compatible browser, and which may have direct access (either through a direct physical connection or over a network) to a scanner. Starting with operation 402, a user may log into the DMS system, which then transmits a client application to a browser located on a client device being used by the browser. As discussed above, the client application may be written in HTML 5 or another suitable standard that allows the browser to issue commands to the scanner.

In operation 404, the user interacts with the client application, and the user initiates scanning within the browser-based client application. As discussed above, this causes a scan command to be sent via the browser to the attached scanner, which results in scanning being initiated, as in operation 406.

In addition to the initiated scan, in operation 406 a virtual or logical connection may be established between the scanner and the DMS. In some implementations, the connection goes between the scanner and directly to a cloud-based storage, which may or may not be integrated with the DMS. In other implementations, the connection may go between the scanner and the DMS server, such as where image conversion needs to be performed. The connection may be provisioned by use of a custom URL that directs data from the scanner to an appropriately allocated storage location in the cloud storage or within the DMS server. Following completion of the scan, pop-up or dialogue box appears in the browser and the user then input any desired metadata such as, e.g., date, index, or keywords.

Following completion of the scan and input of metadata, in operation 408 the scanner notifies the DMS of scan completion via a push method, such as WebSockets. Other suitable non-push methods of notifying the DMS of scan completion may instead be used, such as polling, depending upon the needs of a given implementation. Once notified of scan completion, the DMS then tags the scanned document(s) with the metadata provided in operation 406, and also updates the client app to reflect the presence of the scanned document(s).

In operation 410, the scanned document(s) may be converted to a desired format, as may have been specified by the user in operation 406. As discussed above, this conversion may be performed by a remote server app. Alternatively, the conversion may be performed by the client app, potentially on the data stream on the fly as it is transmitted to the storage.

Finally, in operation 412, the scanned document(s) or image(s) are uploaded to the cloud storage, either directly from the scanner, or through the DMS if the DMS performs an image conversion in operation 410. It should be understood that operation 412 may be carried out contemporaneously with other operations, such as operation 406.

As discussed above, system 200 allows for establishment of virtual or logical links between a scanner and a cloud storage service, which can be controlled using only an industry-standard web browser, and without need for local file copies. Metadata can be assigned prior to scanning, allowing documents to be simultaneously scanned and tagged with metadata into the DMS system 200 in a single step. While the foregoing discussion has focused on use and control of a scanner 204 for digitization of documents to be stored into the DMS system 200, files that are already in digital form, e.g. either separately captured or originated electronically, such as a MS Word document, can benefit from the simplified method of entry into the DMS of system 200.

Typically, to import existing electronic files, documents and images into a cloud DMS such as system 200, at least two distinct steps are needed, roughly corresponding to operation 410 and 412 of method 400, described above. The first is to convert electronic files into a certain format by a save or print function (e.g., print to PDF). The second is to upload the converted electronic files to the DMS in the cloud storage service. On some occasions, in existing systems the user has to identify, by URL or IP address, where such electronic files should be stored, or the user has to initiate a web browser or an app to use drag and drop functions to effect the upload. If electronic files are intended to be managed by the system 200 DMS, when storing to the cloud storage service 206, catalogue metadata such as tag, index or date should be saved with the electronic files. While two or more steps above may be combined by a native DMS application into one step, such native DMS software is typically expensive. Furthermore, as discussed above, the native software typically has to be installed onto the PC 204, and have update versions managed.

I n contrast, system 200 can be configured with a “print to cloud” function. A print to cloud function may be implemented by providing or configuring a printer driver to print images directly to the cloud service 206, with catalogue metadata attached to the files. Essentially, the print to cloud function simply replaces the scanning step (operation 406) for digitizing a document with a printing step. Thus, an existing electronic file is printed to create a data stream similar to that provided by the scanner 202, which is then sent directly to the DMS or cloud service 206, much as the scanner data is sent directly.

In one example, a browser function including a print to cloud feature is enabled by login to the website of the DMS, such as system 200. After logging in, the user opens the documents to be imported to the cloud via a web app client side, such as client side web app 220, in the browser, and clicks a print to cloud button. An example of such a button is depicted as print button 308 of interface 300 of FIG. 3. Then a print dialogue box may appear in the browser UI to select which function is initiated. If the user selects print to cloud, the web app 220 may display a browser UI element such as a dialogue box (not shown) to enable user input of catalogue metadata such as tag, index or data. Alternatively, the metadata UI element 306 may be utilized, much the same as with scanning. After input of catalogue metadata, once a user clicks the print initiation button 308, the web app 220 may import the selected documents to the cloud service. Referring to method 400 in FIG. 4, operation 406 would initiate printing, rather than scanning. The remaining steps of method 400 would be carried out substantially as with scanning.

Alternatively, in some embodiments, the web app 220 may be configured to automatically upload to the cloud all new documents created or received on the client device, within selected upload configurations or file types, and to apply automatic indexing to the documents, in accordance with a selected configuration of auto-indexing. For example, the web app may upload and auto-index all of a user's emails to the cloud storage service. In such an embodiment, operation 406 may be omitted, and instead at least operations 410 and 412 of method 400 may be performed automatically upon creation or receiving each new document.

By eliminating a few steps to import the documents, print to cloud web app feature may drastically decrease the time need for uploading files to the cloud. Also, in comparison with current options for direct cloud printing, e.g. print to iClould or print to Box, a major difference is saving the documents with catalogue metadata for indexing documents in the cloud DMS of system 200. Therefore, a user can easily identify, seek, or retrieve stored documents by using attached metadata such as tags, index, or date, as in a native full DMS.

Receipt Printer Buffer

Currently some POS devices have e-receipt functions. The e-receipt is green and sustainable technology when compared with paper receipts, which imposes a burden on the environment. E-receipts are also comparatively easy to manage by household accounting apps, because the data is in electronic form. I n current e-receipt systems, the user has to input an email address or mobile phone number in a POS device at the cashier to receive the e-receipt. In some cases, contact information such as a mobile phone number or email address have already been registered, such as via a royalty program, e.g. hotel chain, restaurant or merchandise. In other examples, for example ApplePay, credit card information and contact information are already registered in the cloud. In such cases, it is not necessary for the user to input contact information. In still other examples, credit card information may be registered with a particular retailer and previously associated with contact information. However, those circumstances are limited and/or may be tied to a single specific retailer. In each case of a specific retailer, the user has to re-input their contact information. However, to input contact information at the cashier takes time, and if there is a line for the cashier, it may slow checkout, erode sales, and/or make people in the line irritated. Also, there are privacy risks that the information could be misused by employees or hacked, or people behind the user may see the contact information. Some users may hesitate to input contact information considering the delay and potential privacy risk. Therefore, a more secure and effective solution would be welcomed by both retail entities and consumers. While a smartphone-based payment system may obviate the requirement to reenter information as well as allay privacy concerns (the information is typically entered by the user when initially setting up the smartphone for payment), at present many retailers do not yet accept smartphone-based payments.

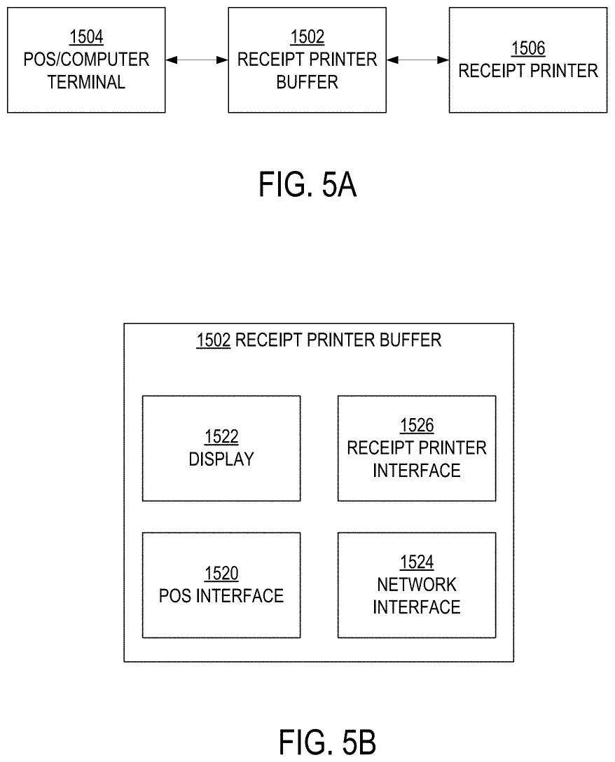

A ‘Receipt Printer Buffer’ may provide a solution to overcome the disadvantages of e-receipts. With reference to FIG. 5A, in a first embodiment, the receipt printer buffer 1502 is implemented as a hardware device that may sit between a POS device 1504 and a receipt printer 1506. The receipt printer buffer 1502 may display receipts as visual codes such as QR codes that can be scanned. The receipt printer buffer 1502 may also be coupled or interact with a receipt app that may be installed on a smartphone (not shown), which can read the QR code to retrieve the receipt. For example, a QR code may indicate a URL or contain an encoded form of a URL to retrieve the receipt. The app may also have a function to save the receipt directly into a DMS, such as system 200, for easy management of the receipt. In place of a QR code, the receipt or URL to retrieve the receipt may be sent to smartphone via a wireless link, such as low-energy Bluetooth, NFC, or another suitable communications technology.

As one example, and referring to FIG. 5B, the receipt printer buffer 1502 may include a POS interface 1520 configured to connect with a POS device 1504. Current POS devices usually have an interface to connect directly with a receipt printer 1506. The receipt printer buffer 1502 may be connected via such interface 1520 and receive a receipt image from the POS device 1504. The receipt printer buffer 1502 may also connect to a cloud service, such as cloud service 206, via Wifi, LAN, or another suitable network technology via a network interface 1524, and may upload the receipt image into a designated location of the cloud. The location may be determined by a DMS, such as system 200, as described above. The receipt printer buffer 1502 may further display the QR-code indicating the location of respective e-receipt upon a display 1522, or send the location via Bluetooth or NFC, as part of network interface 1524. The receipt printer buffer 1502 may sit between a POS device 1502 and a receipt printer 1506, and transfer the received image from the POS device 1502 to the receipt printer 1506 in case a paper receipt is needed. However, if a paper receipt is not needed, the receipt printer buffer 1502 could completely replace the receipt printer 1506. As an advantage, a store implementing a receipt printer buffer 1502 could advertise a completely green solution.

At least some of the functions of the receipt printer buffer 1502 may easily be implemented using similar technology as the print to cloud innovation discussed above. Because the receipt printer buffer 1502, in various embodiments, utilizes the current interface between POS device 1504 and receipt printer 1502, it is compatible with many currently available POS devices 1504. In other embodiments, functionality the receipt printer buffer 1502 may be integrated into the POS device 1504, which in turn would be directly connected to receipt printer 1506. The cost of replacing current POS devices may be considered in determining a desired implementation. For example, a business that has invested in dedicated POS terminals may realize implementation of a receipt printer buffer 1502 as a separate device is the most cost effective solution. Conversely, a business that employs iPads or other general purpose tablets or computers as POS terminals, such as via a software app, may be able to implement the receipt printer buffer 1502 in software, by upgrading the software app.

Alternatively, the functionality of receipt printer buffer 1502 may be incorporated into receipt printer 1506. In such an implementation, receipt printer 1506 may be treated by POS device 1504 as a standard receipt printer, but rather than printing, the customer may be given an option, such as on a display 1522 equipped to the receipt printer 1506, to receive a QR-code and/or a printed receipt. The receipt printer 1506 may generate the e-receipt from the receipt print information received from POS device 1504.

By using a receipt printer buffer 1502, it is not necessary to input or register contact information. The receipt printer buffer 1502 may only need to show the QR-code, which is scanned at the POS terminal. Therefore, the risk to leak contact information is eliminated. Also, scanning the QR-code may be quick and take only a few seconds, and thus time needed to send e-receipt may be almost negligible. Still further, the QR-code may facilitate automatic uploading of the receipt to a DMS such as system 200. In such an embodiment, the operations of method 400 may substantially be followed, except for substituting operation 406 with either the printing functionality described above, or omitting operation 406. Where a user's mobile device includes a corresponding app to read the QR-code and retrieve a receipt, the corresponding app may allow the user to enter any relevant metadata for inclusion with the receipt for filing into the DMS.

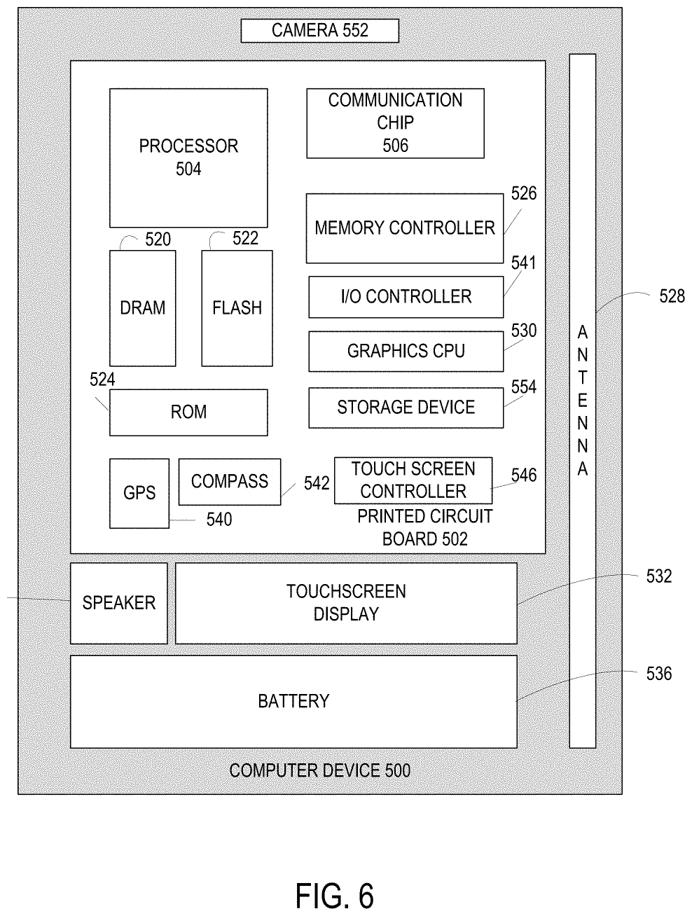

FIG. 6 illustrates an example computer device 500 that may be employed by the apparatuses and/or methods described herein, in accordance with various embodiments. As shown, computer device 500 may include a number of components, such as one or more processor(s) 504 (one shown) and at least one communication chip 506. I n various embodiments, the one or more processor(s) 504 each may include one or more processor cores. I n various embodiments, the one or more processor(s) 504 may include hardware accelerators to complement the one or more processor cores. In various embodiments, the at least one communication chip 506 may be physically and electrically coupled to the one or more processor(s) 504. In further implementations, the communication chip 506 may be part of the one or more processor(s) 504. In various embodiments, computer device 500 may include printed circuit board (PCB) 502. For these embodiments, the one or more processor(s) 504 and communication chip 506 may be disposed thereon. In alternate embodiments, the various components may be coupled without the employment of PCB 502.

Depending on its applications, computer device 500 may include other components that may be physically and electrically coupled to the PCB 502. These other components may include, but are not limited to, memory controller 526, volatile memory (e.g., dynamic random access memory (DRAM) 520), non-volatile memory such as read only memory (ROM) 524, flash memory 522, storage device 554 (e.g., a hard-disk drive (HDD)), an I/O controller 541, a digital signal processor (not shown), a crypto processor (not shown), a graphics processor 530, one or more antennae 528, a display, a touch screen display 532, a touch screen controller 546, a battery 536, an audio codec (not shown), a video codec (not shown), a global positioning system (GPS) device 540, a compass 542, an accelerometer (not shown), a gyroscope (not shown), a speaker 550, a camera 552, and a mass storage device (such as hard disk drive, a solid state drive, compact disk (CD), digital versatile disk (DVD)) (not shown), and so forth.

In some embodiments, the one or more processor(s) 504, flash memory 522, and/or storage device 554 may include associated firmware (not shown) storing programming instructions configured to enable computer device 500, in response to execution of the programming instructions by one or more processor(s) 504, to practice all or selected aspects of the system 100 and method 200 described herein. In various embodiments, these aspects may additionally or alternatively be implemented using hardware separate from the one or more processor(s) 504, flash memory 522, or storage device 554.

The communication chips 506 may enable wired and/or wireless communications for the transfer of data to and from the computer device 500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 506 may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The computer device 500 may include a plurality of communication chips 506. For instance, a first communication chip 506 may be dedicated to shorter range wireless communications such as Wi-Fi and Bluetooth, and a second communication chip 506 may be dedicated to longer range wireless communications such as GPS, EDGE, GPRS, CDMA, WiMAX, LTE, Ev-DO, and others.

I n various implementations, the computer device 500 may be a laptop, a netbook, a notebook, an ultrabook, a smartphone, a computer tablet, a personal digital assistant (PDA), a desktop computer, smart glasses, or a server. In further implementations, the computer device 500 may be any other electronic device that processes data.

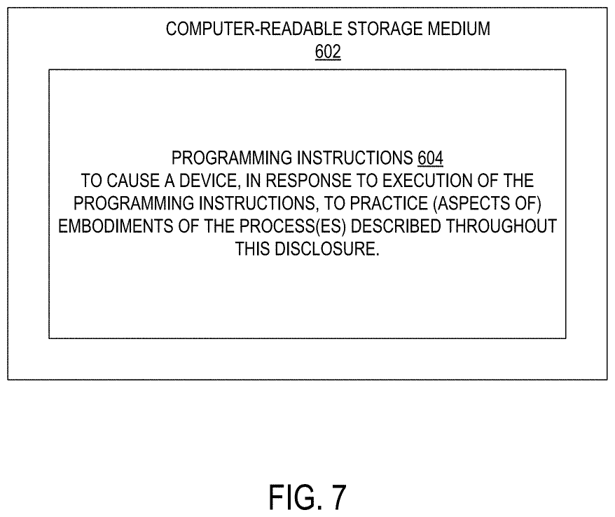

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. FIG. 7 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 602 may include a number of programming instructions 604. Programming instructions 604 may be configured to enable a device, e.g., computer 500, in response to execution of the programming instructions, to implement (aspects of) system 100, file structure 200, and method 300. In alternate embodiments, programming instructions 604 may be disposed on multiple computer-readable non-transitory storage media 602 instead. In still other embodiments, programming instructions 604 may be disposed on computer-readable transitory storage media 602, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non- exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. I n the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways.

This application is intended to cover any adaptations or variations of the embodiments discussed herein. Therefore, it is manifestly intended that embodiments be limited only by the claims and the equivalents thereof.

1. A non-transitory computer-readable medium (CRM) containing instructions that, when executed by an apparatus associated with a document management system, cause the apparatus to:
transmit, to a web browser on a client computer in data communication with a scanner and the apparatus, an interface that includes a scanning control;
transmit, to the web browser, a unique URL corresponding to a document storage location;
receive, from the client computer, a signal that the scanning control has been actuated;
transmit, to the web browser and in response to receipt of the signal, to start a scan of a document with the scanner;
receive, from the client computer via the unique URL, data of the scanned document from the scanner into the document storage location;
receive, from the client computer, metadata for classifying the scanned document within the document management system;
catalog the scanned document within the document management system using the metadata; and
receive, from the client computer, a notification that a scan of a document with the scanner has completed.

2. The CRM of claim 1, wherein the instructions are to further cause the apparatus to:
tag the scanned document with the metadata.

3. The CRM of claim 1, wherein the instructions implement the interface using HTML 5.

4. A non-transitory computer-readable medium (CRM) containing instructions that, when executed by a client computer, cause the client computer to:
display, on a display attached to the client computer, an interface that includes a scanning control;
initiate, upon actuation of the scanning control, a scan of a document with a scanner in communication with the client computer;
receive, at the interface, metadata for classifying the document within a document management system;
transmit, directly from the scanner, a data stream from the scanner of the scan of the document to a remote storage associated with the document management system; and
catalog the scan of the document within the document management system using the metadata.

5. The CRM of claim 4, wherein the instructions are to further cause the apparatus to transmit the metadata to the document management system.

6. The CRM of claim 4, wherein the instructions are to cause the interface to be displayed in a web browser on the client computer.

7. The CRM of claim 6, wherein the instructions implement the interface using HTML 5.

8. The CRM of claim 4, wherein the instructions comprise a client application that is executable in a web browser.

9. The CRM of claim 4, wherein the instructions are to cause the data stream to be transmitted to a remote storage designated by a unique URL.

10. The CRM of claim 4, wherein the instructions are to further cause the client computer to push a notification of scan completion to a document management system.

11. The CRM of claim 10, wherein the instructions are to cause the client computer to push the notification to the document management system using WebSockets.

12. A method for direct scanning of a document into a document management system, comprising:
receiving, at a client computer, a web scanning application;
initiating, with the web scanning application, a scan of a document with a scanner attached to the client computer, in response to a request to scan the document;
receiving, at the client computer, metadata for classifying the document within the document management system; and
uploading the document scan directly to a cloud storage location.

13. The method of claim 12, further comprising:
transmitting, to the document management system, a notification of the completed document scan; and
transmitting the metadata to the document management system.

14. The method of claim 12, further comprising converting the document scan to a predetermined file format prior to uploading.

15. The method of claim 12, wherein the web scanning application is executable by a web browser on the client computer, and further comprising executing the web scanning application in the web browser.

16. The method of claim 15, wherein the web scanning application is implemented using HTML 5.

17. The method of claim 12, wherein the cloud storage location is designated by a unique URL.

18. The method of claim 17, wherein the cloud storage location is provided by the document management system.

19. The method of claim 12, further comprising pushing, by the client computer, a notification of scan completion to a document management system.

20. The method of claim 19, wherein the client computer pushes the notification to the document management system using WebSockets.
